(19) United States
(12) Patent Application Publication
(10) Pub. No.: US 2010/0260959 A1
(43) Pub. Date: Oct. 14, 2010

(54) HOT-MELT EXTRUDED ADHESIVE TAPE

(75) Inventor: Chih-Ming Ou, Taichung County (TW)

Correspondence Address: EGBERT LAW OFFICES, 412 MAIN STREET, 7TH FLOOR, HOUSTON, TX, 77002, US

(73) Assignee: SUN-GOOD GLUE COMPANY, Ltd., Shengang Township (TW)

(21) Appl. No.: 12/421,843

(22) Filed: Apr. 10, 2009

(51) Int. Cl. B32B 33/00

(52) U.S. Cl. 428/41.8

(57) ABSTRACT

The present invention provides a hot-melt extruded adhesive tape, including a banded or foliated carrier and an extruded adhesive incorporated on the peelable surface of the carrier. The extruded adhesive is extruded onto the peelable surface of the carrier or leveled with a thin-profile surface during molding. The thermoplastic adhesive material can be extruded onto the carrier's peelable surface by intermittent feed controller and then arranged at interval. The fabrication efficiency of the thin-profile adhesive tapes is improved, thus saving the material cost and improving the adhesion strength with better advantages and applicability.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a hot-melt extruded adhesive tape, and more particularly to an innovative adhesive tape fabricated by a specific molding method and equipment.

2. Description of Related Art Including Information Disclosed Under 37 CFR 1.97 and 37 CFR 1.98.

In the modem society, there are a great number of handicrafts based on individual interests and job requirements, or based on wholesale or retail reasons. Such handicrafts include decorative scrapbooks, splicing paper products, paper sculptures and sewing products, etc. In addition to some prepared materials, adhesive is an indispensable element during the fabrication of handicrafts. Hot-melt glue, liquid glue or spraying glue was previously used as an adhesive. However, hot-melt glue is not suitable for users, especially for the young or elderly ones, due to certain hazards caused by exposure to higher temperatures. Moreover, hot-melt glue will possibly lead to the damage and deformation of some heat-intolerable materials. The liquid glue makes it easy to stain users' hands or to overflow onto unnecessary places, thus affecting the appearance of finished products. Spraying glue makes it difficult to control accurately the spraying area and quantity; thus, it is only suitable for large-area adhesion in a very limited scope of application.

Additionally, a thermoplastic (or pressure-sensitive) adhesive is another option that is widely applied in the processing of handicrafts. Such thermoplastic adhesive is made available to the users in the foliated or rolled pattern, on which thermoplastic adhesive units are arranged at intervals for peeling-off by the users. So, there is a growing trend that this kind of thermoplastic adhesive will replace conventional ones due to its ease-of-operation, strong security, water-resistance, repeatability and shock-proofing.

The well-designed structural patterns or molding methods of the thermoplastic adhesive are disclosed in many examples, e.g. U.S. Pat. No. 5,935,670, U.S. Pat. No. 6,139,442, U.S. Pat. No. 6,686,016 and CN1760299A; but, it is found from these molding methods that the glue is dripped onto the surface of a carrier (sheet or strip) by means of intermittent dripping, and then the adhesive unit for the peelable carrier is formed through drying and hardening.

The following shortcomings are observed during actual application:
1. Thickness of glue is too much. As the glue is dripped onto the surface of a carrier by means of dripping, the arched surface has a bigger thickness that makes it difficult for thinning even through compression, thus increasing the material cost.
2. The fabrication speed is slow. The dripping occurs from the deadweight of the glue, so the forming process is very slow. The feed speed of the carrier also has to match the dripping speed, leading to slower fabrication speed of a typical molding method.
3. There is poorer adhesion. As an arched surface is shaped from the dripping, the efficient adhesion area and strength is reduced from uneven adhesive surface. For this reason, some pressure is generally applied to the adhesive surface through a tape-rolling process, enabling the surface to be leveled by the deadweight of the tape. While it is difficult to level the surface due to hardening of the adhesive surface, the tight adhesion between the finished adhesive and tape also makes it difficult to peel off the adhesive, or causes the damage of the adhesive.

Thus, to overcome the aforementioned problems of the prior art, it would be an advancement in the art to provide an improved structure that can significantly improve efficacy.

Therefore, the inventor has provided the present invention of practicability after deliberate design and evaluation based on years of experience in the production, development and design of related products.

### BRIEF SUMMARY OF THE INVENTION

Based on the innovation of the hot-melt extruded adhesive tape of the present invention, since the extrusion belongs to an active processing method without waiting for the time interval arising from the dripping, the conveying speed of the carrier can be adjusted, enabling the thermoplastic adhesive material to be incorporated more quickly and efficiently onto the carrier's peelable surface. This can improve greatly the fabrication efficiency and reduce the cost with better applicability and industrial benefits.

Based on the innovation of the hot-melt extruded adhesive tape of the present invention, and since the extrusion port of the extrusion feed mechanism is formed into a flat pattern, the extruded adhesive can be molded directly into a plain pattern without subsequent compression. So, the extruded adhesive on the carrier's peelable surface can become extremely thin, thus saving the material cost with better applicability and industrial benefits.

Based on the innovation of the hot-melt extruded adhesive tape of the present invention, and since the flat and thin-profile adhesive can be fabricated quickly due to the flat design of the extrusion port, the optimum adhesion strength and effect can be realized. So, the present invention presents an improved strength and applicability as compared to typical dripping method.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 shows a perspective view of the preferred embodiment of the hot-melt extruded adhesive tape of present invention.

FIG. 2 shows a partially sectional view of the preferred embodiment of the hot-melt extruded adhesive tape of present invention.

FIG. 3 shows a top plan view of the extruded adhesive of the present invention in a continuously-extended pattern.

FIG. 4 shows a perspective view of the preferred embodiment of present invention that the carrier's peelable surface is covered by the peelable film.

FIG. 5 shows a partial elevation view of the preferred embodiment of the molding equipment of the present invention.

FIG. 6 shows a perspective view of the extrusion feed mechanism of the present invention in actuating state.

FIG. 7 shows a perspective preferred embodiment of the cutting mechanism of the present invention.

### DETAILED DESCRIPTION OF THE INVENTION

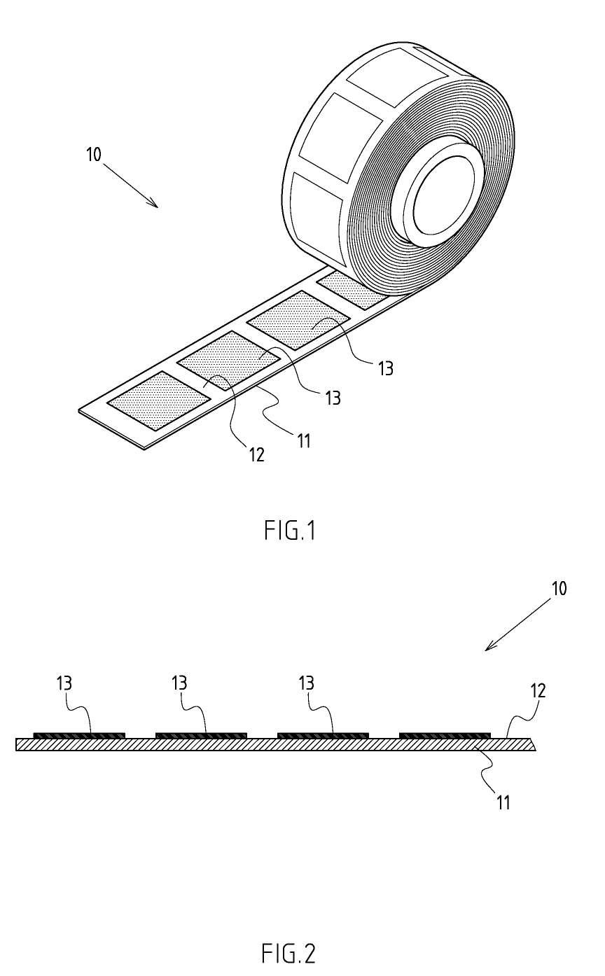

FIGS. 1-3 depict preferred embodiments of hot-melt extruded adhesive tape of the present invention. The embodiments are provided for only explanatory purposes with respect to the patent claims.

The hot-melt extruded adhesive tape 10 comprises a banded, rolled or foliated carrier 11. At one side of which, there is a peelable surface 12. The carrier 11 is made of such materials including but not limited to polyester, polyethylene, PVC, vinyl resin, polystyrene and polypropylene. The carrier 11 disclosed in FIG. 1 is a continuously-extended rolled tape.

There is at least an extruded adhesive 13, made of thermoplastic adhesive materials. The extruded adhesive 13 is extruded onto the peelable surface 12 of the carrier 11, or leveled with a thin-profile surface during molding. The thermoplastic adhesive material is made of such materials including but not limited to thermoplastic rubber (TPV) and thermoplastic elastomers (TPR, TPE).

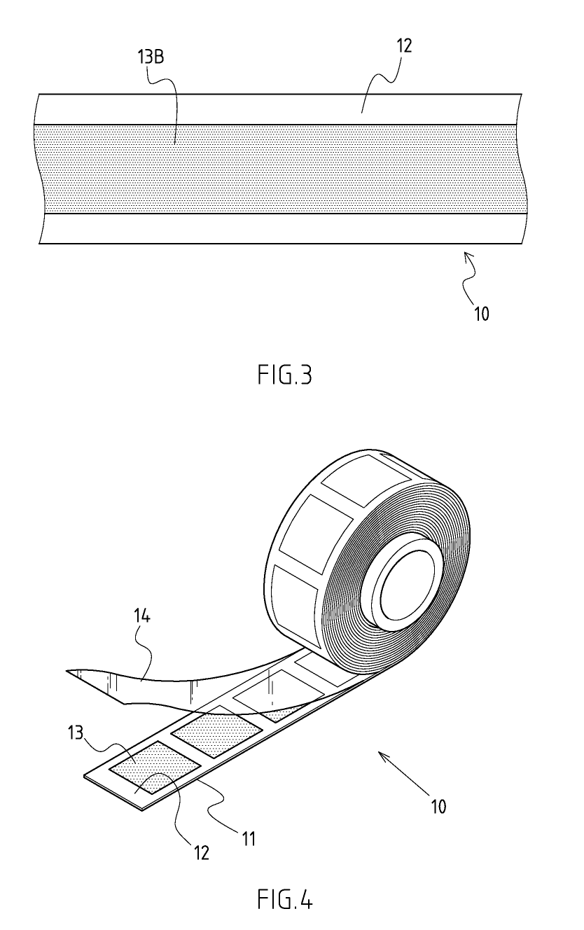

Referring to FIGS. 1 and 2, the extruded adhesives 13 are arranged at intervals. Of which, the extruded adhesive 13B shown in FIG. 3 is formed into a continuously-extended pattern.

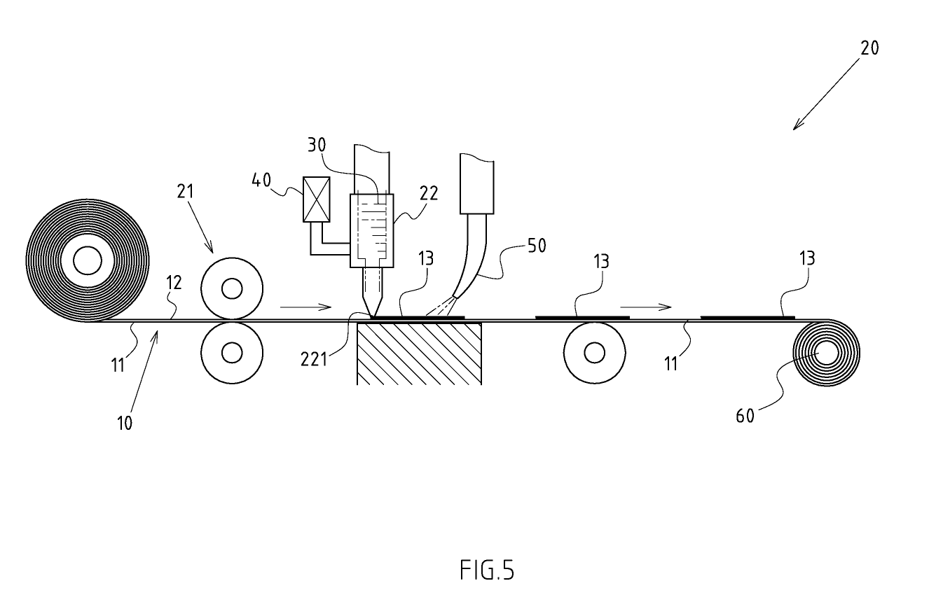

Referring to FIG. 4, the peelable surface 12 of the carrier 11 is covered by a peelable film 14, which is used for covering the extruded adhesives 13. The peeling-off capability of the peelable film 14 is stronger than that of the peelable surface 12 of the carrier 11.

Referring to FIG. 5, the molding equipment 20 of the hot-melt extruded adhesive tape 10 comprises a conveying mechanism 21, used to convey the foliated or banded carrier 11 with a peelable surface 12 along a processing path.

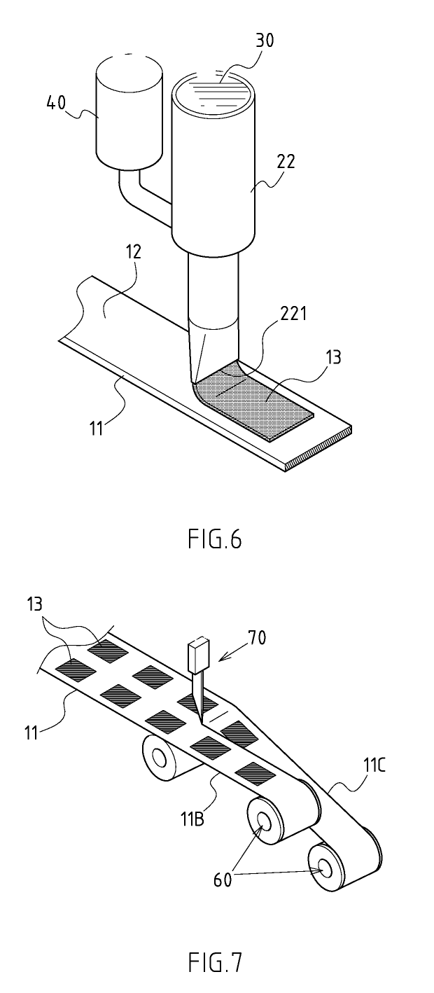

The mechanism 21 includes an extrusion feed mechanism 22, arranged correspondingly to the conveying mechanism 21. The extrusion feed mechanism 22 is provided with an extrusion port 221 corresponding to the peelable surface 12 of the carrier 11, which is used to extrude the thermoplastic adhesive material 30 stored in the extrusion feed mechanism 22 to the peelable surface 12 of the carrier 11. Thus, at least a thin-profile and flat extruded adhesive 13 is formed on the peelable surface 12. The extrusion port 221 can be a flat pattern of predefined width (as shown in FIG. 6), permitting extrusion into flat and expanded glue very quickly.

The mechanism also includes an intermittent controller 40, placed corresponding to the extrusion feed mechanism 22, allowing for intermittent feed of the extruded thermoplastic adhesive material 30. The intermittent controller 40 is a vacuum suction device linked to the inner end of the extrusion port 221 of the extrusion feed mechanism 22. When the intermittent controller 40 is activated, a vacuum suction force is generated to yield a reverse suction force for the thermoplastic adhesive material 30 in the extrusion port 221, thus serving the purpose of intermittent feed control.

There is a hardening mechanism 50, arranged behind the extrusion feed mechanism 22 and used to speed up the hardening of extruded adhesives 13 on the peelable surface 12 into solid adhesive.

With this molding equipment 20, the hot-melt extruded adhesive tape 10 can be molded by the following steps:
(1) Prepare a foliated or banded carrier 11 with a peelable surface 12;
(2) Convey it by a conveying mechanism 21, so as to feed the carrier 11 through an extrusion feed mechanism 22;
(3) Extrude the thermoplastic adhesive material 30 onto the peelable surface 12 of the carrier 11 from the extrusion port 221 of an extrusion feed mechanism 22, so that at least a thin-profile and flat extruded adhesive 13 is formed on the peelable surface 12;
(4) Conduct intermittent feed control by an intermittent controller 40, so that the thermoplastic adhesive material 30 is extruded onto the peelable surface 12 of the carrier 11 to form extruded adhesive 13 at interval; if intermittent feed control is not used, the thermoplastic adhesive material 30 is extruded continuously to form continuously-extended extruded adhesive 13B (as shown in FIG. 3); and
(5) Perform a hardening process by a hardening mechanism 50, allowing the extruded adhesive 13 to be hardened quickly into solid adhesive.

Referring to FIG. 5, a rolling mechanism 60 is placed behind the hardening mechanism 50, so the banded carrier 11 with extruded adhesive 13 is guided into rolled shape.

Referring to FIG. 7, a cutting mechanism 70 is placed behind the hardening mechanism 50, so the carrier 11 with the extruded adhesive 13 is cut into a plurality of carriers 11B, 11C.

1. A hot-melt extruded adhesive tape, comprising:
a banded or foliated carrier, having one side with a peelable surface; and
an extruded adhesive, being comprised of thermoplastic adhesive materials, said extruded adhesive being extruded onto said peelable surface or leveled with a thin-profile surface during molding.

2. The adhesive tape defined in claim 1, wherein said carrier is comprised of a continuously-extended rolled pattern.

3. The adhesive tape defined in claim 1, wherein said peelable surface is covered by a peelable film, the film covering the extruded adhesives and having a peeling-off capability stronger than the peelable surface of the carrier.

4. The adhesive tape defined in claim 1, wherein the extruded adhesive is formed in a continuously-extended pattern.

5. The adhesive tape defined in claim 1, wherein the extruded adhesive is arranged at intervals.

6. The method of forming the adhesive tape defined in claim 1, the method comprising the steps of:
preparing a foliated or banded carrier with a peelable surface;
conveyving the carrier by a conveying mechanism so as to feed the carrier through a feed mechanism;
extruding thermoplastic adhesive material onto the peelable surface of the carrier by the feed mechanism, so that at least a thin-profile and flat extruded adhesive is formed on the peelable surface;
conducting an intermittent feed control so that the thermoplastic adhesive material is extruded onto the peelable surface of the carrier and arranged at interval; if intermittent feed control is not used, the thermoplastic adhesive material is extruded continuously; and
performing a hardening process, enabling the extruded adhesive to be hardened quickly into solid adhesive.

7. The method defined in claim 6, wherein a rolling mechanism is placed behind the hardening mechanism, so the banded carrier with extruded adhesive is guided into rolled shape.

8. The method defined in claim 6, wherein a cutting mechanism is placed behind the hardening mechanism, so the carrier with the extruded adhesive is cut into a plurality of carriers.

9. The molding equipment for making the adhesive tape defined in claim 1, the molding equipment comprising:
a conveying means to convey the foliated or banded carrier with a peelable surface along a processing path;
an extrusion feed means, being arranged correspondingly to the conveying mechanism and being provided with an extrusion port corresponding to the peelable surface of the carrier, extruding thermoplastic adhesive material stored in the extrusion feed mechanism to the peelable surface of the carrier, so that at least a thin-profile and flat extruded adhesive is formed on the peelable surface;
an intermittent controller, being placed correspondingly to the extrusion feed mechanism, allowing for intermittent feed of the extruded thermoplastic adhesive material; and
a hardening mechanism, arranged behind the extrusion feed mechanism, and used to speed up the hardening of extruded adhesives on the peelable surface into solid adhesive.

10. The molding equipment defined in claim 9, wherein a rolling mechanism is placed behind the hardening mechanism, so the banded carrier with extruded adhesive is guided into rolled shape.

11. The molding equipment defined in claim 9, wherein a cutting mechanism is placed behind the hardening mechanism, so the carrier with the extruded adhesive is cut into a plurality of carriers.

12. The molding equipment defined in claim 9, wherein the intermittent controller is a vacuum suction device linked to the inner end of the extrusion port of the extrusion feed mechanism; when the intermittent controller is activated, a vacuum suction force is generated to yield a reverse suction force for the thermoplastic adhesive material in the extrusion port, thus serving the purpose of intermittent feed control.
